(19) United States
(12) Patent Application Publication
(10) Pub. No.: US 2005/0057026 A1
(43) Pub. Date: Mar. 17, 2005

(54) Seating detector

(75) Inventors: Katsu Hattori, Nagoya-shi (JP); Yukihiro Yamamoto, Kariya-shi (JP); Toshiro Maeda, Anjo-shi (JP); Hiroki Satta, Ichinomiya-shi (JP)

Correspondence Address: BURNS DOANE SWECKER & MATHIS L L P, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 10/941,924

(22) Filed: Sep. 16, 2004

(30) Foreign Application Priority Data
Sep. 16, 2003 (JP) 2003-323150

(51) Int. Cl. B60R 21/32

(52) U.S. Cl. 280/735

(57) ABSTRACT

A seating detector comprises a plurality of load sensors provided at a seat for detecting partial loads applied to the seat, a total load calculating means for calculating a total load by summing up the partial loads detected by the load sensors, an occupant determining means for determining an occupant of the seat based on an comparison between the total load calculated by the total load calculating means and at least one of thresholds, a detecting means for detecting fastened/unfastened conditions of the seat belt, a judging means for judging whether or not the total load is in a predetermined range when it is detected by the detecting means that the unfastened condition of the seat belt is switched to the fastened condition, a determination maintaining means for maintaining a determination of the occupant of the seat as a child restraint system when it is judged that the total load is in the predetermined range.

### CROSS REFERENCE TO RELATED APPLICATIONS

This application is based on and claims priority under 35 U.S.C. § 119 to Japanese Patent Application 2003-323150, filed on Sep. 16, 2003, the entire content of which is incorporated herein by reference.

### FIELD OF THE INVENTION

This invention generally relates to a seating detector for detecting whether or not a seat is occupied by human.

### BACKGROUND

Recently, a vehicle equips an air bag apparatus at front portion thereof (on a driver seat or on a passenger seat) for improving safety on a collision. When the vehicle crashes into an object due to an accident, the air bag apparatus outputs a signal (an operation signal) to an air bag actuator based on a signal from the collision-detecting sensor for actuating an inflator and inflating an air bag instantaneously.

On this account, for improving the safety on the vehicle collision, a vehicle having a function for switching a place where the air bag is inflated considering a direction of the impact due to the vehicle collision has been on a market. In this case, the air bag needs to be actuated based on an accurate determination whether or not a passenger is sitting on the vehicle seat. The judge whether or not the passenger is sitting on the vehicle seat, especially on the passenger seat, needs to be executed more precisely because such seat may be variously occupied by a adult, a children or a baby on a child seat (Child Restraint System, hereinafter referred to as CRS).

So far, known seating detectors are disclosed in JP2002-255010A2, JP2002-255011A2, and JP2002-87132A2.

In JP2002-255010A2, the state in which the CRS is attached is determined depending on the length of the seat belt being used. Specifically, if the length of the seat belt being used is short and the load is widely applied to the surface of the vehicle seat, it is supposed that the CRS is attached to be facing forward of the vehicle. In addition, if the length of the seat belt being used is extremely long and the load is widely applied to the surface of the vehicle seat, it is supposed that the CRS is attached to be facing backward of the vehicle.

In JP2002-255011A2, the seat belt includes ALR (automatic locking retractor) function and ELR (emergency locking retractor) function, and these functions can be switched to be used by the seat belt. When the ALR is used, it is determined that the CRS is attached at the seat.

In JP2002-87132A2, a known method for determining the occupant is disclosed. Such method determines types of occupant by means of a seating area (total load), template matching, and edges obtained by summing up load differences between the sensors.

The values of the total load when the vehicle seat is occupied by the CRS are similar to the values of the total load and the width when the vehicle seat is occupied by an adult or a child, however, according to the template matching, a characteristic of the vehicle seat on which the CRS is attached is different from a characteristic of the vehicle seat which is occupied by human. In addition, according to the edge detection, an edge amount when the vehicle seat is occupied by the CRS is different from an edge amount when the vehicle seat is occupied by human. Thus, the CRS may be misclassified as human when the total load applied to the vehicle seat is relatively large due to a load applied to the vehicle seat when the seat belt is fastening tightly. To improve the detecting accuracy when a high load is applied to the vehicle seat, the template matching and the edge detection are applied to the seat detector.

According to the known invention disclosed in JP2002-255010A2, the occupant determination is examined based on the used amount of the seat belt, however; the used amount of the seat belt may be changed depending on a passenger's size and posture, or a shape of the CRS. Thus, the used amount of the seat belt is inappropriate to make the correct occupant determination.

According to the known seating detector disclosed in JP2002-255011A2, it is determined that the CRS is attached on the vehicle seat when the ALR is functioning, however; some vehicle includes the ALR at only the rear seats, not at the front seats, which decreases the versatility of such seating detector. Further, when the ELR is functioning, the state in which the CRS is attached is determined based on the condition of the seat belt which is not pulled to the end, however; if a locking clip is used at the seat belt to loose and keep the length of the belt properly, the CRS can be attached while the ELR is functioned. Under such condition, the state in which the CRS is attached is not determined correctly.

According to the known invention disclosed in JP2002-87132A2, the occupant may be misclassified when a shape of a bottom portion of the CRS is similar to a hip shape of human body. In addition, the occupant may be misclassified when a result of the template matching when the CRS is attached on the vehicle seat is similar to a result of the template matching when human is seating on the vehicle seat. Further, when the CRS includes a bottom whose shape cause a small pressure difference on the edge thereof, so that the detecting accuracy may be decreased.

Thus, a need exists for a seating detector to determine whether the seat is occupied by human or occupied by a CRS accurately.

### SUMMARY OF THE INVENTION

According to an aspect of the present invention, a seating detector comprises a plurality of load sensors provided at a seat for detecting partial loads applied to the seat, a total load calculating means for calculating a total load by summing up the partial loads detected by the load sensors, an occupant determining means for determining an occupant of the seat based on an comparison between the total load calculated by the total load calculating means and at least one of thresholds, a detecting means for detecting fastened/unfastened conditions of the seat belt, a judging means for judging whether or not the total load is in a predetermined range when it is detected by the detecting means that the unfastened condition of the seat belt is switched to the fastened condition, a determination maintaining means for maintaining a determination of the occupant of the seat as a child restraint system when it is judged that the total load is in the predetermined range.

According to another aspect of the present invention, a seating detector comprises a plurality of cells provided at a seating surface of a seat to be defined by a two-dimensional array including rows and columns for detecting partial loads applied to the seating surface of the seat, a calculating means for calculating a number of the cells being “on” which indicating the number of the cells whose partial pressure exceeds a predetermined pressure, an occupant determining means for determining an occupant of the seat based on an comparison between the number of the cells being “on” calculated by the calculating means and at least one of thresholds, a detecting means for detecting fastened/unfastened conditions of the seat belt, a judging means for judging whether or not the number of the cells being “on” is in a predetermined range when it is detected by the detecting means that the unfastened condition of the seat belt is switched to the fastened condition, and a determination maintaining means for maintaining a determination of the occupant of the seat as a child restraint system when it is judged that the number of the cells being “on” is in the predetermined range.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a block diagram indicating an electric configuration when a seating detector is mounted to a vehicle;

FIG. 2 illustrates a flat view of a configuration of pressure sensors;

FIG. 3 illustrates explanation views indicating determinations of an actuation of an air bag on a passenger seat;

FIG. 4A, FIG. 4B and FIG. 4C illustrates timing charts indicating each determining process;

FIG. 5 illustrates a flow chart indicating a main routine of a buckle SW calculation process;

FIG. 6 illustrates a flow chart indicating a sub routine of the buckle SW calculation process;

FIG. 7 illustrates a flow chart indicating an occupant determining process, and

FIG. 8 illustrates a block diagram indicating determining conditions of the occupant determination.

### DETAILED DESCRIPTION

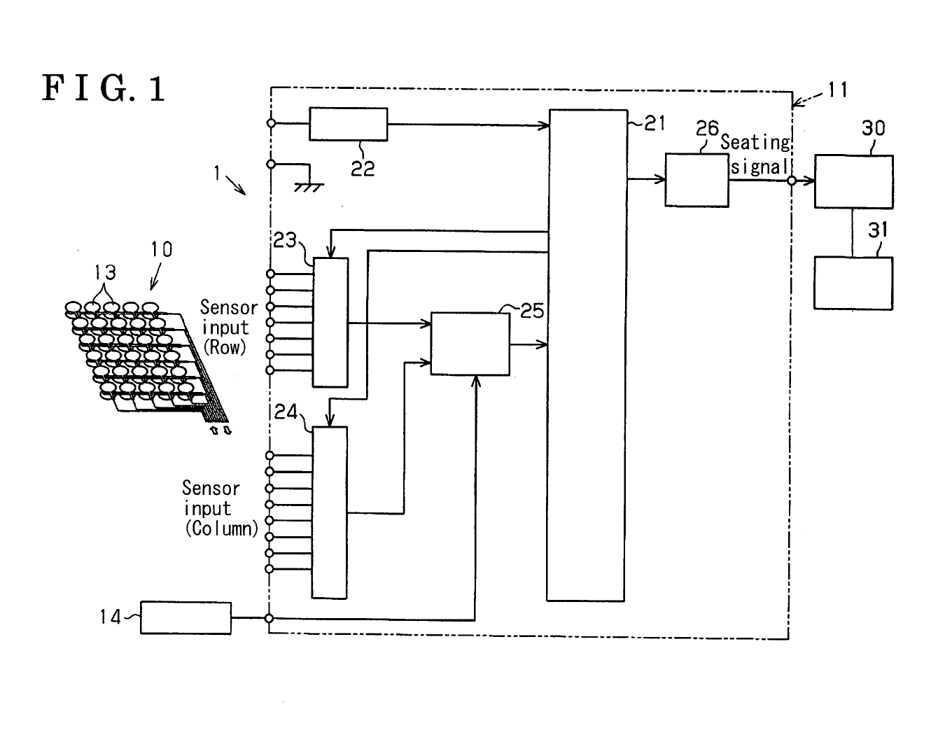

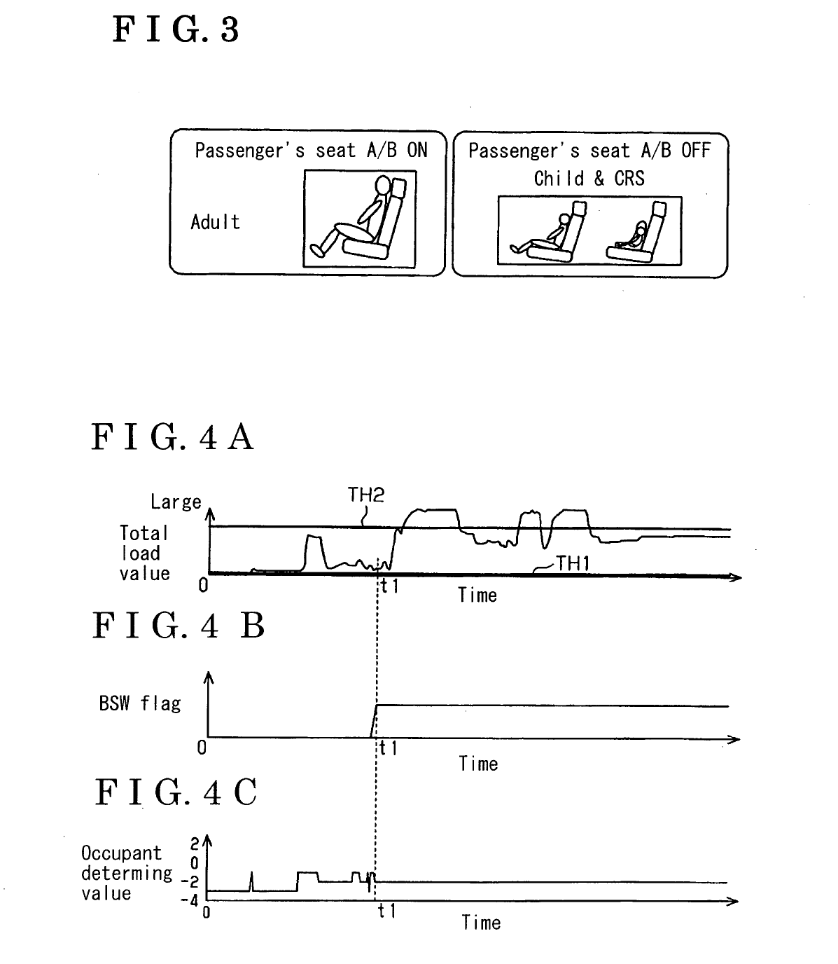

An embodiment of the present invention will be explained hereinbelow referring to attached drawings FIG. 1 through FIG. 8.

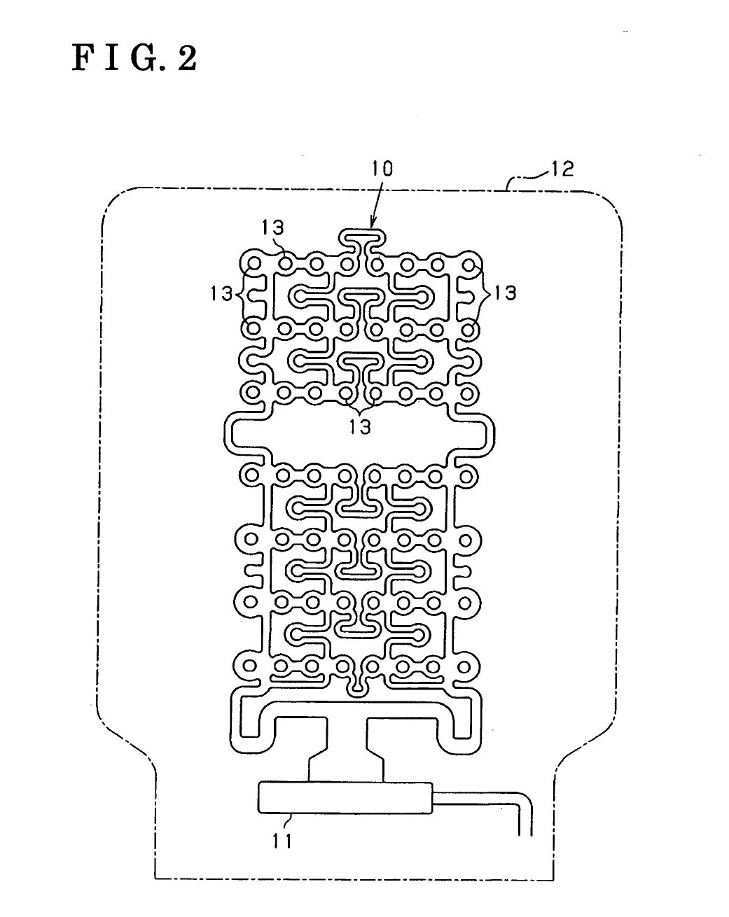

FIG. 1 illustrates a block diagram indicating an electric configuration of the seating detector 1 mounted to a vehicle, and FIG. 2 illustrates a flat view of the configuration of the seating detector 1. As shown in FIG. 2, the seating detector 1 includes a plurality of pressure sensors 10 and a controller 11.

As shown in FIG. 2, the pressure sensors 10 provided on the seating surface of the vehicle seat 12 (seat cushion) includes cells 13 (load sensors) for detecting the pressure applied to the seating surface of the vehicle seat 12. Position of each cells 13 are defined by a matrix structure, specifically a two-dimensional array of rows in a width direction of the vehicle seat (i) and columns in a longitudinal direction of the vehicle seat 0). Position of each cell 13 defined by such matrix structure, and each cell 13 detects a pressure (a partial pressure as a partial load) X (i, j) at the position thereof. Each detected partial pressure X (i, j) is input into the controller 11.

The partial pressures X (i, j) are detected by fifty-six cells 13 provided at the seating surface of the vehicle seat 12 to be a 7×8 matrix array in the embodiment of the current invention, however, such configuration is one of the applicable examples and may be changed.

As shown in FIG. 1, the controller 11 includes a CPU 21 (central processing unit) (total load calculating means, judging means, determination maintaining means, calculating means and determination releasing means), a power supply circuit 22, a first switching circuit 23, a second switching circuit 24, an A/D (analog/digital) convert circuit 25 and an output circuit 26.

The CPU 21 determines the seating condition of the vehicle seat 12 based on a controlling program and initial data and the like stored in a ROM (read only memory) in advance. The power supply circuit 22 transforms a voltage of a power (e.g. 12V) provided from the battery (not shown) into a predetermined voltage (e.g. 5V) and supplies the transformed power to the CPU 21.

The first switching circuit 23 and the second switching circuit 24 being connected to the pressure sensor 10 selectively switch the rows and the columns of the pressure sensor 10 based on the switching signal from the CPU 21, and sequentially transmit the detected partial pressure X (i, j) into the A/D convert circuit 25. The partial pressure X (i, j) being an analog signal is converted into a digital signal at the A/D converts circuit 25 and transmitted into the CPU 21.

The CPU 21 temporally stores each partial pressure X (i, j) in the memory respectively. Such partial pressure X (i, j) is used for determining the seating condition of the vehicle seat 12. Generally, possible conditions of the vehicle seat 12 on the passenger's side may be a condition in which an adult is sitting thereon, a condition in which a child is sitting thereon and a condition in which a CRS (a child restraint system or a child seat) is attached thereon. The CPU 21 calculates a total load value by summing up all partial pressures X (i, j) detected at cells 13 and compares such total load value to predetermined thresholds. Based on the comparison result, the CPU 21 classifies the occupant of the vehicle seat 12.

The seating detector 1 includes a buckle switch 14 (detecting means) to be turned on/off based on the fastened/unfastened state of a buckle of a seat belt. The buckle switch 14 outputs a signal (hereinbelow referred to as a buckle SW signal) into the CPU 21 through the A/D convert circuit 25. The CPU 21 refers a load characteristic under a condition where the buckle is fastened to determine the occupant of the vehicle seat 12.

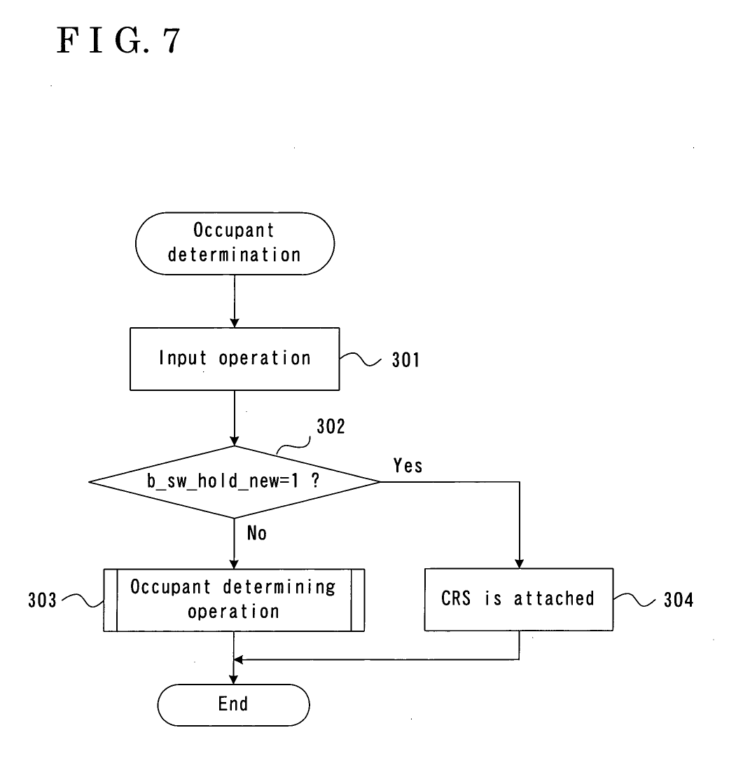

One end of the output circuit 26 is connected to the CPU 21 for transmitting the information of the occupant of the vehicle seat 12 determined at the CPU 21. The other end of the output circuit is connected to an air bag ECU (electronic control unit) 30 for transmitting a seating signal detected at the ECU 21 which is indicating the occupant of the vehicle seat 12 to the air bag ECU. As shown in FIG. 7, the seating signal transmitted into the air bag ECU 30 permits (turns on) an actuation of the air bag when the adult is sitting on the passenger seat, and prohibit (turn off) the actuation of an air bag 31 when the child is sitting or the CRS is attached on the passenger seat.

The air bag ECU 30 outputs a signal (operation signal) into an air bag actuator to actuate an inflator if needed based on the seating signal and a signal from a crash sensor, then the air bags 31 on the driver's seat and the passenger's seat are inflated instantaneously. In this way, the actuation of the air bag 31 at the passenger seat is preferably controlled based on the seating signal corresponding to the occupant of the vehicle seat 12 the like.

FIG. 4 illustrates timing charts indicating each obtained value when the CRS is attached on the vehicles eat 12. FIG. 4A indicates the total load value, FIG. 4B indicates a BSW flag and FIG. 4C indicates an occupant determining value which is a result of an occupant determination. The BSW flag is set to be “1” based on buckle SW signal “ON” when the buckle of the seat belt is fastened. On the other hand, the BSW flag is set to be “0” based on buckle SW signal “OFF” when the buckle of the seat belt is unfastened. In the occupant determination, the occupant determining value is set to be “2” when the seat is occupied by an adult of large size, set to be “1” when the seat is occupied by an adult of small size, set to be “−1” when the seat is occupied by a child, set to be “−2” when the seat is occupied by CRS, and set to be “−3” when no load is applied to the seat. Based on such values, the seating signal for allowing the actuation of the air bag is output when the occupant determining value is “2” or “1”. On the other hand, the seating signal for prohibiting the actuation of the air bag is output when the occupant determining value is “−1”, “−2” or “−3”.

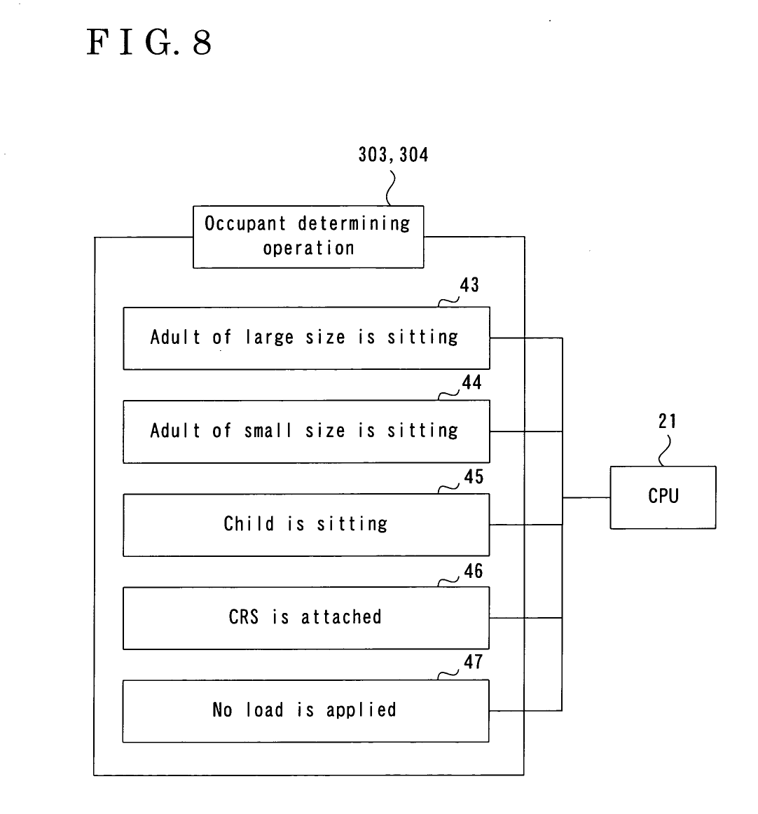

In the occupant determination, following states of the vehicle seat are determined as shown in FIG. 8; a state in which the seat is occupied by an adult of large size (43), a state in which the seat is occupied by an adult of small size (44), a state in which the seat is occupied by a child (45), a state in which the CRS is attached on the seat (46) and a state in which no load is applied to the seat (47).

As shown in FIG. 4A and FIG. 4B, the total load value exists within a relatively limited range (total load value≦TH2) at point t1 where the BSW flag being “0” is turned into “1”. This is due to that a total load value before the CRS is fixed to the seat by fastening the seat belt corresponds a total load value of a eight of the CRS so that total load value is smaller than the total load value when the seat is occupied by the adult. A characteristic of the case when the seat is occupied by the adult is different from the aforementioned characteristic when the CRS is attached on the vehicle seat. Generally, the buckle is fastened after the seat is occupied by the adult so that the total load value has been marked at high both before and after the seat is occupied by the adult. Based on such characteristics, when the total load value at the point t1 where the buckle is fastened is less than a predetermined load value, the determination whether or not the CRS is attached on the seat is executed, then a result of such determination is held so as to prevent an incorrect judgment due to a load which is temporally applied to the vehicle seat 12. At this point, it is determined whether or not the seat is occupied by the child if such predetermined value is set by considering a load applied to the seat by a child. Hereinbelow the predetermined value is referred to as an upper threshold TH2. The upper threshold TH2 is set to be smaller than a threshold used for determining whether or not the seat is occupied by the adult.

In such configuration where only the upper limit threshold for regulating the upper limit is set, the CRS determination will be held when the buckle of a vacant seat 12 is fastened. If such vacant seat 12 whose buckle has been fastened is occupied by an adult, the actuation of the air bag will be prohibited. Thus, another predetermined load value for regulating the lower limit (hereinbelow referred to as a lower limit threshold TH1) is prepared. Using such lower limit threshold TH1, it is determined whether or not no load is applied to the seat. Thus, the CRS determination is not held when the buckle of a vacant seat 12 is fastened, so that the air bag is actuated appropriately. The lower threshold TH1 may be set to be “0”, however, the lower threshold TH1 is set to be a preferable value assuming that a case when the seat is occupied by a small thing or a preload value of the sensor in the embodiment.

The CRS determination is held based on a comparison between the total load value and the upper and lower thresholds. Specifically, the CRS determination is held as shown in FIG. 4C even if the total load value is temporally increased, so that the occupant determination is hold stably.

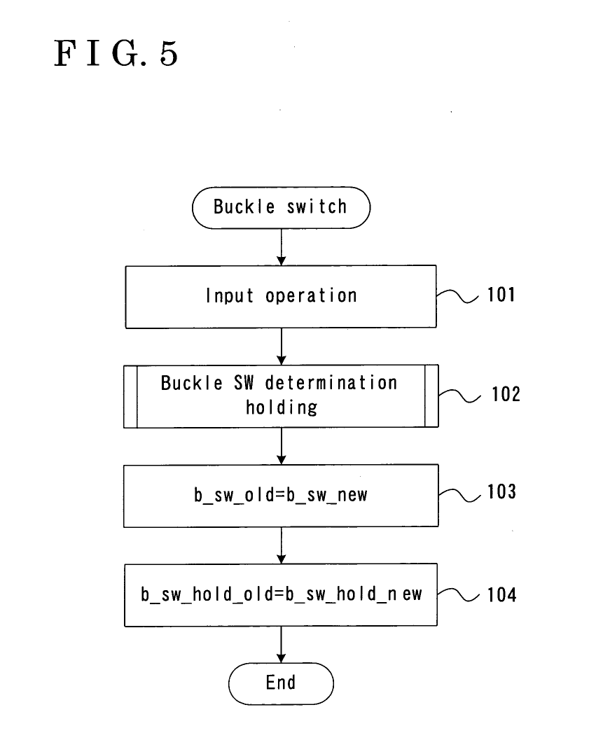

A determining process of the seating detector according to the embodiment along with the process executed by the controller 11 will be explained hereinbelow referring to attached drawings FIG. 5 through FIG. 7. FIG. 5 illustrates a flowchart of a buckle switch operation for monitoring the buckle switch 14. This process is repeated with interrupting at a predetermined interval. First, the CPU 21 obtains various data in Step 101. Specifically, the total load value, a new buckle SW signal b_sw_new input through the A/D convert circuit 25, a previous buckle SW signal b_sw_old stored in the memory, a previous buckle SW determination holding flag b_sw_hold_old are input into the CPU 21. The current buckle SW signal b_sw_new and the previous buckle SW signal b_sw_old are set to be “1” when the buckle is fastened, and set to be “0” when the buckle is unfastened. As described later, the buckle SW determination holding flag b_sw_hold_old is set to be “1” when the CRS determination is held, and set to be “0” when the CRS determination is not held.

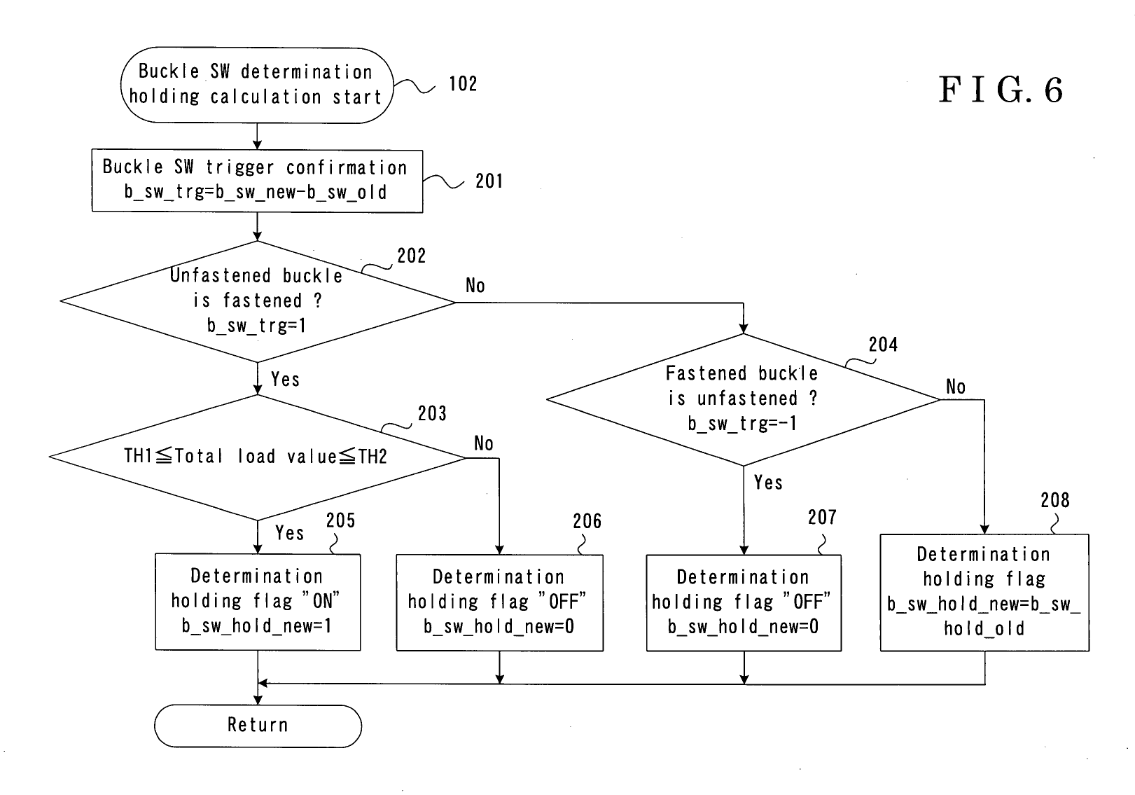

The CPU 21 then proceeds to Step 102 to execute a subroutine in FIG. 6 for setting the buckle SW determination holding flag. In the subroutine, the CPU proceeds to Step 201 and executes a buckle SW trigger confirmation process. In this process, the CPU 21 deducts the previous buckle SW signal b_sw_old from the new buckle SW signal b_sw_new to obtain a buckle SW trigger b_sw_trg. The buckle SW trigger b_sw_trg becomes “1 (=1−0)” when the unfastened buckle is fastened from the previous operation to the current operation. The buckle SW trigger b_sw_trg becomes “0 (=1−1, 0−0)” when the state of the buckle has not been changed from the previous operation to the current operation. The buckle SW trigger vb_sw_trg becomes “−1 (=0−1)” when the fastened buckle is unfastened from the previous operation to the current operation.

Then, the CPU 21 determines whether or not the unfastened buckle is fastened based on the buckle SW trigger b_sw_trg. When it is determined that the unfastened buckle is fastened based on “1” buckle SW trigger b_sw_trg, the CPU 21 proceeds to Step 203. In Step 203, the CPU 21 determines whether or not the total load value exists within a range being equal to or more than the lower limit threshold TH1 and equal to or less than the upper threshold TH2. As aforementioned above, the lower threshold TH1 is set to be a preferable value for determining whether or not the vehicle seat 12 is vacant, and the upper threshold TH2 being smaller than the total load value of the vehicle seat 12 on which an adult of small size is seating is set to be a preferable value for determining whether or not the CRS is attached on the vehicle seat 12.

When the total load value is in the range being equal to or more than the lower limit threshold TH1 and equal to or less than the upper limit threshold TH 2, the CPU 21 proceeds to Step 205. In Step 205, the current buckle SW determination holding flag b_sw_hold_new is set to be “1” for holding the CRS determination. On the other hand, the total load value is not in the aforementioned range, the CPU proceeds to Step 206. In Step 206, the current buckle SW determination holding flag b_sw_hold_new is set to be “0”.

When it is not determined that the unfastened buckle is fastened, the CPU 21 proceeds to Step 204. In Step 204, it is determined that the fastened buckle is unfastened based on whether or not the buckle SW trigger b_sw_trg is “−1”. When it is determined that the fastened buckle is fastened, the CPU 21 proceeds to Step 207. In step 207, the current buckle SW determination holding flag b_sw_hold_new is set to be “0” for releasing the CRS determination. On the other hand, it is not determined that the fastened buckle is unfastened in Step 204, in other words, it is determined that the buckle is not operated, the CPU 21 proceeds to Step 208. In step 208, the previous buckle SW determination holding flag b_sw_hold_old is set as the current buckle SW determination holding flag b_sw_hold_new. Thus, holding or releasing condition of the CRS determination is continued.

After renewing the current buckle SW determination holding flag b_sw_hold_new in Step 205, 206, 207 or 208, the CPU 21 goes back to Step 103 in the original routine shown in FIG. 5. In Step 103, the current buckle SW signal b_sw_new is set to the previous buckle SW signal b_sw_old. Then, the CPU 21 proceeds to the Step 104. In Step 104, the new buckle SW determination holding flag b_sw_hold_new is set to the previous buckle SW determination holding flag b_sw_hold_old. After such operations, the process is once ended.

The occupant determination process executed by the CPU 21 will be explained based on FIG. 7. FIG. 7 illustrates a flowchart indicating the process of the occupant determination. This process is also repeated with interrupting at a predetermined interval. The CPU 21 obtains various data in Step 301. Specifically, the CPU 21 inputs new partial pressures X (i, j) through the A/D convert circuit 25 and calculates the total load value by summing the new partial pressures X (i, j). The CPU 21 also inputs the buckle SW determination holding flag b_sw_hold_new set through the aforementioned process.

The CPU 21 proceeds to Step 302. In Step 302, the CPU 21 determines whether or not the buckle SW determination holding flag b_sw_hold_new is “1”. When the buckle SW determination holding flag b_sw_hold_new is “1”, the CPU 21 proceeds to Step 303 and determines the state in which the CRS is attached. Specifically, the determination of the state in which the CRS is attached is maintained as long as the buckle SW determination holding flag b_sw_hold_new is “1”. On the other hand, when the buckle SW determination holding flag b_sw_hold_new is “0”, the CPU 21 proceeds to Step 304 and executes an occupant determining operation (occupant determining means). In the occupant determining operation, the CPU 21 compares the total load value to thresholds and classifies the condition of the vehicle seat 12 into five states, a state in which the seat is occupied by an adult of large size (43), a state in which the seat is occupied by an adult of small size (44), a state in which the seat is occupied by a child (45), a state in which the CRS is attached on the seat (46) and a state in which no load is applied to the seat (47). After finishing the operations in Step 303 or Step 304, the process is once ended.

According to an aspect of the embodiment of the present invention, when it is determined that the total load value is equal to or more than the lower threshold TH1 and equal to or less than the upper threshold TH 2 at the point when it is detected that the unfastened seat belt (buckle) is fastened, the occupant determination is maintained as the state in which the CRS is attached. Thus, unstable occupant determination due to the temporally fluctuation of the load applied after the determination is maintained can be prevented.

According to another aspect of the embodiment of the present invention, the determination of the state in which the CRS is attached being maintained is preferably released depending on the detected condition of the seat belt (buckle) switched from the fastened state to the unfastened state which corresponds to the seat condition where the CRS is not attached.

Thus, the seating detector according to the invention includes a prohibiting means for prohibiting the actuation of the air bag when the occupant is determined and maintained as the CRS by the determination maintaining means. Providing such prohibiting means at the CPU 21, the CPU 21 can prohibits the actuation of the air bag 31 through the air bag ECU 30 when the occupant is determined and maintained as the CRS.

In the embodiment of the present invention, the total load value is compared to the thresholds to execute the occupant determination, however, the number of the cell 13 being “ON” whose partial pressure X (i, j) exceeds a predetermined pressure may be summed alternatively by a calculating means and used to be compared to thresholds to determine the occupant on the vehicle seat. In this case, the state in which the CRS is attached is determined and maintained if the number of the cells 13 being “ON” is in a predetermined range when it is detected that the seat belt (buckle) is switched from the fastened state to the unfastened state.

Further, in the embodiment of the present invention, the total load value is obtained by summing up the partial pressures X (i, j) of the all cells 13, however, a load value of a certain cell which is not important for detecting the partial pressure may be ignored for convenience when the total load value is calculated.

Furthermore, in the embodiment of the present invention, the condition of the seat belt being fastened or unfastened is detected by the buckle switch 14 for detecting the condition of the buckle being fastened or unfastened, however, the condition of the seat belt can be detected by a sensor.

Still further, in the embodiment of the current invention, the pressure sensor 10 has a matrix structure defined by a two-dimensional array of rows in the width direction of the vehicle seat and columns in the longitudinal direction of the vehicle seat being crossing at right angles, however, the pressure sensor 10 may have another structure such as that the rows and the columns is crossing obliquely unless the pressure distribution on the seating surface of the vehicle seat has ordinality.

Yet still further in the embodiment of the current invention, a plurality of the cells 13 is provided on the vehicle seat to be defined by a two-dimensional array of rows and columns, however, a plurality of load sensors may be provided for detecting a deformation of a frame of the vehicle seat and the like which are used as a partial load.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A seating detector, comprising:
a plurality of load sensors provided at a seat for detecting partial loads applied to the seat;
a total load calculating means for calculating a total load by summing up the partial loads detected by the load sensors;
an occupant determining means for determining an occupant of the seat based on an comparison between the total load calculated by the total load calculating means and at least one of thresholds;
a detecting means for detecting fastened/unfastened conditions of the seat belt;
a judging means for judging whether or not the total load is in a predetermined range when it is detected by the detecting means that the unfastened condition of the seat belt is switched to the fastened condition, and
a determination maintaining means for maintaining a determination of the occupant of the seat as a child restraint system when it is judged that the total load is in the predetermined range.

2. A seating detector according to claim 1, wherein the plurality of load sensors is provided at a seating surface of the seat to be defined by a two-dimensional array including rows and columns for detecting a partial pressure applied to the seating surface as the partial load.

3. A seating detector, comprising:
a plurality of cells provided at a seating surface of a seat to be defined by a two-dimensional array including rows and columns for detecting partial loads applied to the seating surface of the seat;
a calculating means for calculating a number of the cells being “on” which indicating the number of the cells whose partial pressure exceeds a predetermined pressure;
an occupant determining means for determining an occupant of the seat based on an comparison between the number of the cells being “on” calculated by the calculating means and at least one of thresholds;
a detecting means for detecting fastened/unfastened conditions of the seat belt;
a judging means for judging whether or not the number of the cells being “on” is in a predetermined range when it is detected by the detecting means that the unfastened condition of the seat belt is switched to the fastened condition, and
a determination maintaining means for maintaining a determination of the occupant of the seat as a child restraint system when it is judged that the number of the cells being “on” is in the predetermined range.

4. A seating detector according to claim 1, wherein a determination releasing means is provided for releasing the maintained determination of the occupant of the seat as the child restraint system when it is detected by the detecting means that the fastened condition of the seat belt is switched to the unfastened condition.

5. A seating detector according to claim 2, wherein a determination releasing means is provided for releasing the maintained determination of the occupant of the seat as the child restraint system when it is detected by the detecting means that the fastened condition of the seat belt is switched to the unfastened condition.

6. A seating detector according to claim 3, wherein a determination releasing means is provided for releasing the maintained determination of the occupant of the seat as the child restraint system when it is detected by the detecting means that the fastened condition of the seat belt is switched to the unfastened condition.

7. A seating detector according to claim 1, a prohibiting means is provided for prohibiting an actuation of an air bag when the determination of the occupant of the seat as the child restraint system is maintained by the determination maintaining means.

8. A seating detector according to claim 2, a prohibiting means is provided for prohibiting an actuation of an air bag when the determination of the occupant of the seat as the child restraint system is maintained by the determination maintaining means.

9. A seating detector according to claim 3, a prohibiting means is provided for prohibiting an actuation of an air bag when the determination of the occupant of the seat as the child restraint system is maintained by the determination maintaining means.

10. A seating detector according to claim 4, a prohibiting means is provided for prohibiting an actuation of an air bag when the determination of the occupant of the seat as the child restraint system is maintained by the determination maintaining means.

11. A seating detector according to claim 1, wherein seven types of conditions of the seat are determined; a condition in which the buckle of the seat belt is fastened, a condition in which the buckle of the seat belt is unfastened, a condition in which the seat is occupied by an adult of large size, a condition in which the seat is occupied by an adult of small size, a condition when the seat is occupied by a child, a condition in which the seat is occupied by the child restraint system and a condition in which no load is applied to the seat.

12. A seating detector according to claim 2, wherein seven types of conditions of the seat are determined; a condition in which the buckle of the seat belt is fastened, a condition in which the buckle of the seat belt is unfastened, a condition in which the seat is occupied by an adult of large size, a condition in which the seat is occupied by an adult of small size, a condition when the seat is occupied by a child, a condition in which the seat is occupied by the child restraint system and a condition in which no load is applied to the seat.

13. A seating detector according to claim 3, wherein seven types of conditions of the seat are determined; a condition in which the buckle of the seat belt is fastened, a condition in which the buckle of the seat belt is unfastened, a condition in which the seat is occupied by an adult of large size, a condition in which the seat is occupied by an adult of small size, a condition when the seat is occupied by a child, a condition in which the seat is occupied by the child restraint system and a condition in which no load is applied to the seat.

14. A seating detector according to claim 4, wherein seven types of conditions of the seat are determined; a condition in which the buckle of the seat belt is fastened, a condition in which the buckle of the seat belt is unfastened, a condition in which the seat is occupied by an adult of large size, a condition in which the seat is occupied by an adult of small size, a condition when the seat is occupied by a child, a condition in which the seat is occupied by the child restraint system and a condition in which no load is applied to the seat.

15. A seating detector according to claim 5, wherein seven types of conditions of the seat are determined; a condition in which the buckle of the seat belt is fastened, a condition in which the buckle of the seat belt is unfastened, a condition in which the seat is occupied by an adult of large size, a condition in which the seat is occupied by an adult of small size, a condition when the seat is occupied by a child, a condition in which the seat is occupied by the child restraint system and a condition in which no load is applied to the seat.
